(19) United States
(12) Patent Application Publication
(10) Pub. No.: US 2017/0346659 A1
(43) Pub. Date: Nov. 30, 2017

(54) METHOD AND APPARATUS FOR ADDRESS RESOLUTION

(71) Applicant: Telefonaktiebolaget LM Ericsson (publ), Stockholm (SE)

(72) Inventors: Qianxi Lu, Beijing (CN); Rui Fan, Beijing (CN); Gunnar Mildh, Sollentuna (SE)

(21) Appl. No.: 15/527,079

(22) PCT Filed: Dec. 9, 2014
(86) PCT No.: PCT/CN2014/093365

§ 371 Date: May 16, 2017

(51) Int. Cl. H04L 12/64

(52) U.S. Cl. CPC H04L 12/6418; H04L 2012/6424; H04L 2012/6448

(57) ABSTRACT

Embodiments of the invention generally relate to address resolution in a wireless communication system. The access node may locally determine, responsive to receiving a second-layer network address associated with a destination communication device from a source communication device in the wireless communication system, a first-layer network address of the destination communication device from the second-layer network address. The access node may send, responsive to the first-layer network address being unavailable, a request for the first-layer network address to an address resolution server in the wireless communication system. In this way, the time and resources for address resolution may be saved, and the efficiency of the address resolution may be improved.

### TECHNICAL FIELD

Embodiments of the present invention generally relate to the field of communications, and more particularly to a method and apparatus for address resolution in a wireless communication system.

### BACKGROUND

Following Long Term Evolution (LTE), major effort has recently been paid to the development of Ultra-Dense Network (UDN), which may be deployed in areas with high traffic loads and therefore may provide high data rates. In the UDN, the distances between access nodes (ANs) are envisioned to be tens of meters and less. Over-provision may be achieved with such an extremely dense grid of access nodes.

Generally, the UDN can simultaneously support the communication among multiple user equipments (UEs). The UEs may communicate with each other via one or more access nodes (ANs) or other entities. The communication between source UE and destination UE often requires a plurality of network addresses of the destination UE. As used herein, the term “source UE” refers to the UE that initiates the communication, and the term “destination UE” refers to the UE which is the target with which the source UE wants to communicate

A certain kind of network addresses of the destination UE are often required to establish the communication. The certain kind of network addresses may be obtained through an address resolution. As used herein, the term “address resolution” refers to a process of mapping or translating one network address to a further network address. Some examples of the network addresses may include a layer-2 address, such as a Media Access Control (MAC) address, a Radio Link Control (RLC) address and the like, a layer-3 address, such as an Internet Protocol (IP) address, and an application layer address.

In a computer communication network, an example approach of address resolution lies in broadcasting of an address request among computers. For example, if a computer needs to communicate with another computer, it may broadcast a request for a network address of the computer to be communicated with, such as a MAC address. The request may carry another network address, such as an IP address. The computer having the IP address makes a response with its own MAC address. However, such broadcasting of a request may cause message flooding and severe interferences, which would be much more severe in a wireless communication system.

### SUMMARY

Generally, embodiments of the present invention provide an efficient solution for the address resolution in the wireless communication system.

In a first aspect, a method implemented at least in part by an access node of the address resolution in a wireless communication system is provided. The method comprises: receiving a second-layer network address associated with a destination communication device from a source communication device in the wireless communication system; responsive to receiving the second-layer network address, locally determining a first-layer network address of the destination communication device; and responsive to the first-layer network address being unavailable, sending a request for the first-layer network address to an address resolution server in the wireless communication system. The corresponding computer program is also provided.

In a second aspect, a method implemented at least in part by a gateway entity of address resolution in a wireless communication system is provided. The method comprising: responsive to receiving a request for a first-layer network address of a destination communication device from a source communication device in the wireless communication system, locally determining the first-layer network address from a second-layer network address associated with the destination communication device; and sending the first-layer network address to the source communication device, such that the source communication device directly communicates with the destination communication device based on the first-layer network address. The corresponding computer program is also provided.

In a third aspect, an apparatus implemented at least in part by an access node for address resolution in a wireless communication system is provided. The apparatus comprising: a receiving module configured to receive a second-layer network address associated with a destination communication device from a source communication device in the wireless communication system; an address determining module configured to, responsive to the second-layer network address being received, locally determine a first-layer network address of the destination communication device from the second-layer network address; and a request module configured to, responsive to the first-layer network address being unavailable, send a request for the first-layer network address to an address resolution server in the wireless communication system.

In a fourth aspect, an apparatus implemented at least in part by a gateway entity for address resolution in a wireless communication system is provided. The apparatus comprising: a request receiving module configured to receive a request for a first-layer network address of a destination communication device from a source communication device in the wireless communication system; a determining module configured to, responsive to receiving the request, locally determine the first-layer network address from a second-layer network address associated with the destination communication device; and an address sending module configured to send the first-layer network address to the source communication device, such that the source communication device directly communicates with the destination communication device based on the first-layer network address.

In a fifth aspect, an apparatus implemented at least in part by an access node for address resolution in a wireless communication system is provided. The apparatus comprises a processor and a memory including computer-executable instructions which, when executed by the processor, cause the apparatus to: receive a second-layer network address associated with a destination communication device from a source communication device in the wireless communication system; responsive to receiving the second-layer network address, locally determine a first-layer network address of destination communication device from the second-layer network address associated with the destination communication device; and, responsive to the first-layer network address being unavailable, send a request for the first-layer network address to an address resolution server in the wireless communication system.

In a sixth aspect, an apparatus implemented at least in part by a gateway entity for an address resolution in a wireless communication system is provided. The apparatus comprises a processor and a memory including computer-executable instructions which, when executed by the processor, cause the apparatus to: responsive to receiving a request for a first-layer network address of a destination communication device from a source communication device in the wireless communication system, locally determine the first-layer network address from a second-layer network address associated with the destination communication device; and send the first-layer network address to the source communication device, such that the source communication device directly communicates with the destination communication device based on the first-layer network address.

In a seventh aspect, an apparatus implemented at least in part by an access node for address resolution in a wireless communication system is provided. The apparatus comprises processing means adapted to: receive a second-layer network address associated with a destination communication device from a source communication device in the wireless communication system; responsive to receiving the second-layer network address, locally determine a first-layer network address of destination communication device from the second-layer network address associated with the destination communication device; and, responsive to the first-layer network address being unavailable, send a request for the first-layer network address to an address resolution server in the wireless communication system.

In an eighth aspect, an apparatus implemented at least in part by a gateway entity for address resolution in a wireless communication system. The apparatus comprises processing means adapted to: responsive to receiving a request for a first-layer network address of a destination communication device from a source communication device in the wireless communication system, locally determine the first-layer network address from a second-layer network address associated with the destination communication device; and send the first-layer network address to the source communication device, such that the source communication device directly communicates with the destination communication device based on the first-layer network address.

According to embodiments of the present invention, in one aspect, the access node may locally determine the network address of the destination communication device. In another aspect, the gateway entity may send the network address of the destination communication device to the source communication device, and therefore the source communication device may directly communicate with the destination communication device later based on the address. In this way, the time and resources for address resolution may be saved, and the efficiency of the address resolution may be improved.

### BRIEF DESCRIPTION OF THE DRAWINGS

FIG. 1 illustrates an environment of a wireless communication system in which embodiments of the present invention may be implemented;

FIG. 2 illustrates a flowchart of a method for address resolution in accordance with one embodiment of the present invention;

FIG. 3 illustrates an example signaling flow of the method as shown in FIG. 2 according to one embodiment of the present invention;

FIG. 4 illustrates a flowchart of a method for address resolution in accordance with one embodiment of the present invention;

FIG. 5 illustrates an example cascading topology of multiple Local Gateways (L-GWs) according to one embodiment of the present invention;

FIG. 6 illustrates an example signaling flow of the method as shown in FIG. 4 according to one embodiment of the present invention;

FIG. 7 illustrates a block diagram of an apparatus for address resolution in accordance with one embodiment of the present invention;

FIG. 8 illustrates a block diagram of an apparatus for address resolution in accordance with one embodiment of the present invention; and

FIG. 9 illustrates a simplified block diagram of an apparatus that is suitable for use in implementing embodiments of the present invention.

### DETAILED DESCRIPTION

The present invention will now be discussed with reference to several example embodiments. It should be understood that these embodiments are discussed only for the purpose of enabling those skilled persons in the art to better understand and thus implement the present invention, rather than suggesting any limitations on the scope of the present invention.

As used herein, the term “access node” (AN) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) refers to any device that is capable of communicating with the AN. By way of example, the UE may include a terminal, a Mobile Terminal (MT), a Subscriber Station (SS), a Portable Subscriber Station (PSS), a Mobile Station (MS), or an Access Terminal (AT).

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

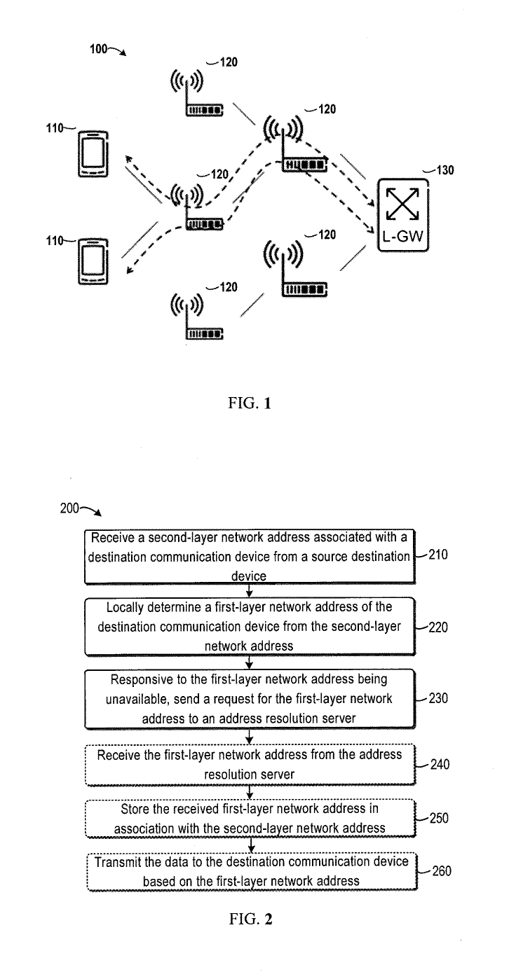

FIG. 1 shows an environment of a wireless communication system 100 in which embodiments of the present invention may be implemented. As shown, two or more UEs 110 may communicate with each other through one or more ANs 120. In this example, there are two UEs 110 and five ANs 120. This is only for the purpose of illustration without suggesting the limitations on the number of UEs 110 and ANs 120. There may be any suitable number of UEs 110 in communication with the AN 120.

The communications between the UEs 110 may be performed according to any suitable communication protocols including, but not limited to, the first generation (1G), the second generation (2G), 2.5G, 2.75G, the third generation (3G), the fourth generation (4G) communication protocols, 4.5G, and/or any other protocols either currently known or to be developed in the future.

As shown in FIG. 1, the system 100 also comprises a Local Gateway (L-GW) 130. As used herein, the L-GW 130 refers to a user plane node of a core network of the wireless communication system 100. The L-GW 130 may communicate with the AN 120 via any suitable interface. For example, in one embodiment, the L-GW 130 may use a wired connection to communicate with the AN 120. In another embodiment, the L-GW 130 may also use air interface when suitable. In this example as shown in FIG. 1, there is one L-GW 130. This is only for the purpose of illustration without suggesting limitations on the number of the L-GW 130. In another embodiment, there may be more L-GWs 130. Normally, different Local GWs have supervisions of different groups of ANs, but it is also possible that some L-GWs have overlapping supervision of the group of ANs.

As described above, the communication between UEs 110 requires a certain kind of network address of the destination UE 110. For example, a UE has the layer-3 address (e.g. the IP address) and wants the layer-2 address (MAC address) for the connection.

An example approach of address resolution uses the L-GW 130 as a specific address resolution server for the communication between the UEs 110. Specifically, whenever the source UE 110 wants to initiate communication, the source UE 110 may transmit data, along with the IP address of the destination UE 110, to the L-GW 130 through one or more ANs 120. Then, the L-GW 130 may retrieve the MAC address of the destination UE 110 from a local database and forward the data to the destination UE 110 based on the retrieved MAC address. Even when the source and destination UEs 110 are located within the same cell, the data has to be forwarded through the L-GW 130. Such forwarding would waste limited resources and cause latency.

FIG. 2 shows a flowchart of a method 200 for the address resolution in accordance with one embodiment of the present invention. It would be appreciated that the method 200 may be implemented by an AN 120 as shown in FIG. 1.

As shown, the method 200 is entered at step 210, where the AN 120 receives from a source communication device a network address associated with a destination communication device. According to embodiments of the present invention, the network address may be sent alone or along with data to be transmitted to the destination communication device.

As used herein, the term of “source communication device” refers to a device that initiates communication, and the term “destination communication device” refers to a device that terminates communication. For example, in one embodiment, the source and destination communication devices may be UE 110 and/or a further AN 120 as shown in FIG. 1. Specifically, in one embodiment, the network address is received from the source UE 110, and the network address may be associated with the destination AN 120. Examples of the network address associated with the destination AN 120 include, but are not limited to, the network address of the destination UE 110.

In the context of the present invention, the term “source AN” refers to the AN that serves the source UE during the communication. The term “destination AN” refers to the AN that serves the destination UE during the communication. The method 200 will be described below in the case that the source UE 110 acts as the source communication device, the destination AN 120 acts as the destination communication device, and the source AN 120 implements the method 200.

Then, the method 200 proceeds to step 220, where the source AN 120 locally determines a further network address of the destination AN 120 from the network address associated with the destination AN 120, such as the network address of the destination UE 110, received from the source UE 110.

As described above, the network address may include, but not limited to, a layer-2 address, such as a MAC address, a RLC address and the like, a layer-3 address, such as an IP address, and a higher-layer address. For the convenience of description, hereinafter, the network address to be determined is referred to as a “first-layer network address”, and the network address received from the source communication device, such as the source UE 110, is referred to as a “second-layer network address”.

According to embodiments of the present invention, the first-layer network address is lower than the second-layer addresses. For example, in one embodiment, the first-layer network address may be a data link layer address, and the second-layer network address may be an application layer address. Specifically, in one embodiment, the data link layer address may be a MAC address. The application layer address may be an IP address. Alternatively or additionally, the application layer address may be a user identity (ID) of an instant messaging application (e.g. Facebook, Twitter). According to embodiments of the present invention, the address resolution is to find the first-layer address mapping to the second-layer address. For the convenience of description, the method 200 will be described below in a scenario where the first-layer network address is a MAC address and the second-layer network address is an IP address. It should be appreciated that the first-layer or second-layer network addresses may be a network address of any suitable layer. The scope of the present invention will not be limited in this regard.

According to embodiments of the present invention, the source AN 120 may determine the MAC address of the destination AN 120 by performing a local search. Specifically, in one embodiment, the MAC and IP addresses of a plurality of UEs 110 and/or ANs 120 associated therewith may be stored in storage that may be accessible to the AN 120. Examples of the storage include, but are not limited to, local storage of the source AN 120 or network storage remotely located from the source AN 120.

By way of example, in one embodiment, the source AN 120 may have storage for the function of address resolution. The storage may include a cache, a buffer or any other type of storage devices. In the storage, the MAC addresses of a UE 110 and/or its associated AN 120 are stored in association with the associated IP addresses. In this example, the source AN 120 may have an access to the storage and search for the MAC address of the destination AN 120 based on the IP address of the destination UE 110.

Next, the method proceeds to step 230, where the source AN 120 sends a request for the MAC address to an address resolution server responsive to the MAC address being unavailable at step 220. The reason of the unavailable MAC address could be that no historic address of the destination UE 110 has been stored, or that the address mapping relationship between the MAC address and the IP address hasn't been timely updated. As used herein, the term “address resolution server” refers to a server having the function of address resolution, such as address mapping and/or translating and the like. According to embodiments of the present invention, examples of the address resolution server include, but are not limited to, the L-GW 130 and a further AN 120 as shown in FIG. 1. For example, in one embodiment, during handover of UE 110 from one AN 120 to a further AN 120, the previous source AN 120 would act as the address resolution server before the network address is transmitted to the latter source AN. It should be noted that the address resolution server may be any suitable server that may provide the function of address resolution. The scope of the present invention will not be limited in this regard. According to embodiments of the present invention, the request may be sent alone or along with data to be transmitted to the destination communication device.

With the local determination of the network address of the destination communication device at the source AN 120, the address resolution for communication in the wireless communication system 100, the latency of the address resolution may be reduced, and the communication resources may be saved. As described above, in one conventional approach, the UE 110 has to send an address resolution request to the address resolution server such as the L-GW 130 whenever it wants to initiate a communication. Such a process is time consuming and resource wasting. According to embodiments of the present invention, the source AN 120 may locally determine the lower layer network address of the destination AN 120. The source UE 110 could send the data and the higher layer network address of the destination UE without any address resolution request, leaving address resolution to its own serving AN. In this way, the efficiency of the address resolution may be improved. Moreover, UE 110 may not need to keep storage of the mapping relationship in its limited memory.

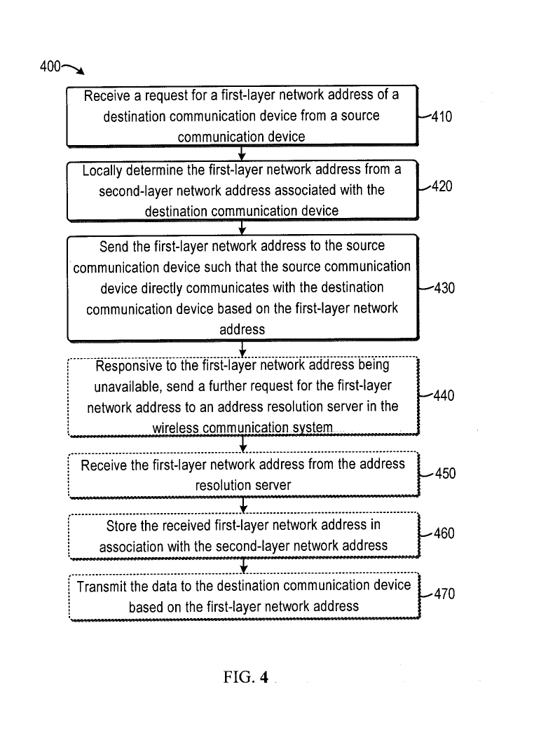

Still with reference to FIG. 2, after sending a request for the MAC address of the destination AN 120 to the address resolution server at step 230, the method 200 proceeds to step 240, where the source AN 120 receives the MAC address from the address resolution server. As described above, in one embodiment, the address resolution server may be the L-GW 130. The process of address resolution implemented by the L-GW 130 will be detailed below, for example, with reference to FIGS. 4-6.

Next, at step 250, the source AN 120 stores the received MAC address in association with the IP address associated with the destination AN 120, such as the IP address of the destination UE 110, for a subsequent search and determination. As described above, the received MAC address may be stored in storage in association with the IP address. The storage may include local storage and network storage that is accessible to the source AN 120. In this way, the storage for the function of address resolution may be updated.

According to embodiments of the present invention, if the source AN 120 obtains the requested MAC address of the destination AN 120, it may continue the communication. For example, in one embodiment, as described above, the source AN 120 receives from the source UE 110 the IP address of the destination UE 110 along with the data to be transmitted to the destination UE 110. In this example, as shown in FIG. 2, the source AN 120 may transmit the data to the destination AN 120 based on the MAC address at step 260. Then, the destination AN 120 would forward the data to the destination UE 110 according to the IP address of the destination UE 110.

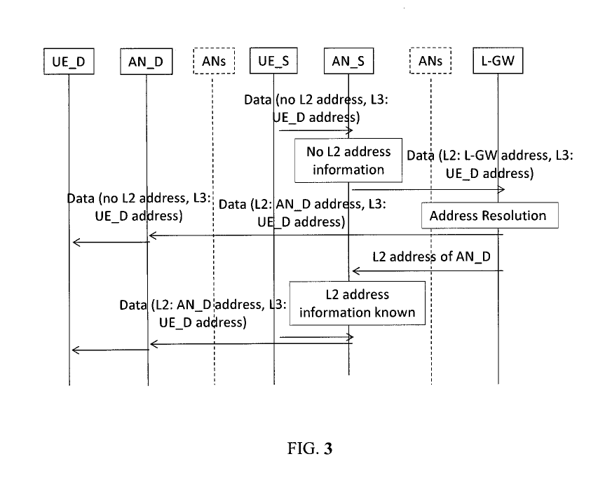

FIG. 3 shows an example signaling flow of the method 200 as shown in FIG. 2 according to one embodiment of the present invention. In this example, the source AN (AN_S) provides the address resolution for the communication from the source UE (UE_S) to the destination UE (US_D).

As shown in FIG. 3, the AN_S receives data to be transmitted to the UE_D. In addition to the data, an address indication including two fields with one indicating the layer-2 (L2) address and the other indicating the layer-3 (L3) address are sent from the UE_S to the AN_S. As shown, the field of the L2 address is empty, and the field of the L3 address is the L3 address of the UE_D. As described above, this address indication may be used to request the L2 address of the UE_D or that of the destination access node (AN_D). In this example, it is aimed at the L2 address of the AN_D.

Responsive to the address indication, the AN_S locally determines the L2 address of the AN_D. As shown, in this example, the AN_S finds no related information locally, and then it sends an address request to the L-GW as the address resolution server. This request is sent along with data. This request also includes two fields of the L2 address and the L3 address, wherein the field of the L2 address is set to the L2 address of the L-GW. Such setting of the field indicates that the L2 address of the AN_D is requested. As shown, the request may be sent via one or more ANs as illustrated in the dashed line.

After the L-GW determines the L2 address of the AN_D upon the address resolution, it forwards the data to the AN_D including the L2 address of the AN_S. Upon the reception of the L2 address of the AN_D, the AN_S stores the L2 address associated with the L3 address. In this way, the AN_S may locally determine the L2 address of the AN_D when the address is requested subsequently, and therefore it may directly forward the data to the A_ND without requesting the L-GW to perform the address resolution.

FIG. 4 shows a flowchart of a method 400 for the address resolution in accordance with one embodiment of the present invention. It would be appreciated that the method 400 may be implemented by an L-GW 130 as shown in FIG. 1.

As shown, the method 400 is entered at step 410, where the L-GW 130 receives from a source communication device a request for the first-layer network address of a destination communication device. As described above, according to embodiments of the present invention, the request may be sent alone or along with data to be transmitted to the destination communication device. According to embodiments of the present invention, the source and destination communication devices may be an AN 120 as shown in FIG. 1. It should be noted that the source and destination communication devices may be any suitable device that may initiate and terminate the communication. The scope of the present invention will not be limited in this regard. The method 400 will be described below in the case that the ANs 110 act as the source and destination communication devices.

According to embodiments of the present invention, the request may include an identification of the destination AN 120. In one embodiment, the request may include a second-layer network address associated with the destination AN 120. For example, in one embodiment, if the address of the destination AN 120 is to be requested, the request may include a second-layer network address of the destination UE 110. Alternatively, in another embodiment, the request may include the destination AN 120's own second-layer network address.

As described above, the first-layer and second-layer network addresses may include, but not limited to, a layer-2 address, such as a MAC address, a RLC address and the like, a layer-3 address, such as an IP address, and a higher-layer address. For the convenience of description, the method 400 will be described below in a scenario where the first-layer network address is a MAC address and the second-layer network address is an IP address. It should be appreciated that the first-layer or second-layer network addresses may be a network address of any suitable layer. The scope of the present invention will not be limited in this regard.

Then, the method 400 proceeds to step 420, where the L-GW 130 locally determines the MAC address of the destination AN 120 from the IP address associated with the destination AN 120 responsive to receiving the request for the MAC address. As described above, in one embodiment, the IP address may the destination AN 120's own IP address. Alternatively, in another embodiment, it may be the IP address of the destination UE 110.

As described above, according to embodiments of the present invention, the L-GW 130 may determine the MAC address of the destination AN 120 by performing a local search. For example, in one embodiment, the MAC and IP addresses of a plurality of UEs 110 and/or ANs 120 associated therewith may be stored in storage that may be accessible to the L-GW 130, such as local storage of the L-GW 130 and network storage remotely located from the L-GW 130.

Specifically, in one embodiment, the L-GW 130 may have storage for the function of address resolution, such as a cache, a buffer or any other type of storage devices. In the storage, the MAC addresses of a UE 110 and/or its associated AN 120 are stored in association with the associated IP addresses. The L-GW 130 may have an access to the storage and search for the MAC address based on the IP address.

Next, the method proceeds to step 430, where the L-GW 130 sends (430) the MAC address of the destination AN 120 to the source AN 120. In this way, the source AN 120 may use the MAC address to directly communicate with the destination AN 120 later.

As described above, in one conventional approach, the address resolution by the L-GW has to be performed for each communication. According to embodiments of the present invention, the required address may be sent to the source communication device, such that the source communication device may directly communicate with the destination communication device later. For example, the source and destination UEs would communicate with each other through their serving ANs, wherein communication data would not be transmitted through L-GW. Thus, the time and resources for address resolution may be saved, and the efficiency of the address resolution may be improved.

Then, the method proceeds to step 440, where the L-GW 130 sends a request for the MAC address to an address resolution server responsive to the MAC address being unavailable at step 430. As described above, the request may also be sent alone or along with data to be transmitted to the destination communication device. According to embodiments of the present invention, the address resolution server may be a further L-GW 130 as shown in FIG. 1. It should be noted that the address resolution server may be any suitable server that may provide the function of address resolution. The scope of the present invention will not be limited in this regard.

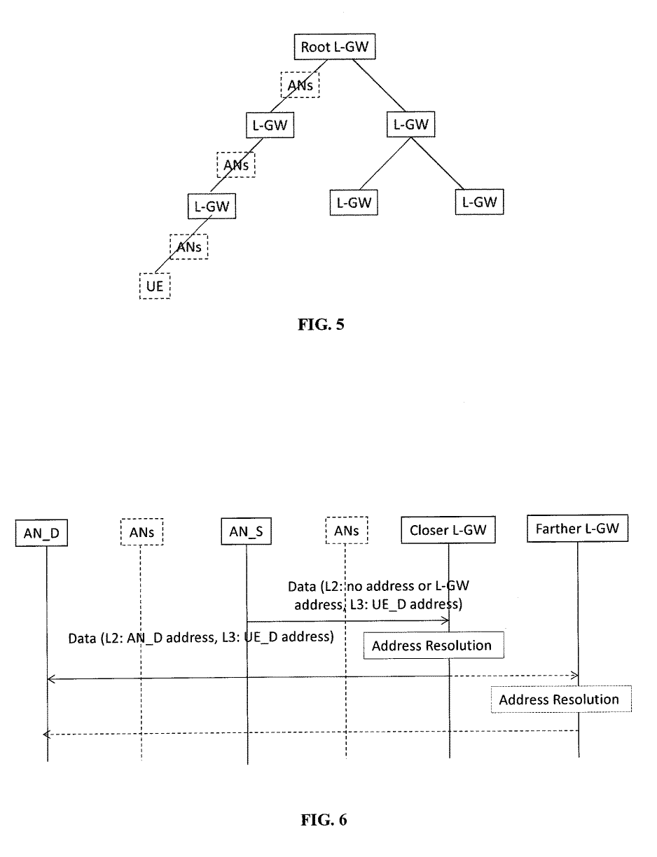

FIG. 5 illustrates an example cascading topology of multiple L-GWs according to one embodiment of the present invention. As shown, there are multi-level L-GWs, and the L-GWs between neighboring levels may be communicated directly or through one or more ANs. A root L-GW may communicate with and supervise L-GWs of lower levels.

Still with reference to FIG. 4, the method 400 then proceeds to step 450, where the L-GW 130 receives the MAC address of the destination AN 120 from the address resolution server, such as a further L-GW 130. Next, at step 460, the AN 120 stores the received MAC address in association with the associated IP address for a subsequent search and determination. As described above, the associated IP address may include the IP address of the destination UE 110 and/or the destination AN 120. The addresses may be stored in storage that includes, but is not limited to, local storage and network storage that is accessible to the L-GW 130, such that the storage for the function of address resolution may be updated.

According to embodiments of the present invention, if the L-GW 130 obtains the requested MAC address of the destination AN 120, it may continue the communication. For example, in one embodiment, as described above, the L-GW 130 receives from the source AN 120 the request for the MAC address of the destination AN 120 along with the data to be transmitted to the destination UE 110. In this example, as shown in FIG. 4, the L-GW 130 may transmit the data to the destination AN 120 based on the MAC address at step 470.

FIG. 6 shows an example signaling flow of the method 400 as shown in FIG. 4 according to one embodiment of the present invention. As shown in FIG. 6, in this example, the topology of the L-GW is cascading of multi-level L-GWs as shown in FIG. 5. Specifically, the closer L-GW provides the first address resolution for the communication, and the farther L-GW provides the second address resolution responsive to the failure of the first address resolution. As used herein, the closer L-GW refers to an L-GW that may directly communicate with the UE or AN requesting address resolution and provides the address resolution for the first time. It may not the physically closest L-GW to the source AN. The further L-GW refers to a root L-GW as shown in FIG. 5 that supervises the closer L-GW and other L-GWs if available and provides the further address resolution for the second time.

In this example, the closer L-GW receives an address request along with data to be transmitted to the AN_D. The request includes two address fields with one indicating the L2 address and the other indicating the L3 address. As shown in FIG. 6, the field of the L2 address may be empty or set to the L2 address of the closer L-GW, and the field of the L3 address is the L3 address of the UE_D. With such setting of the field, the request for the AN_D is indicated.

Responsive to the request, the closer L-GW locally determines the L2 address of the AN_D. If the closer L-GW determines the L2 address, it forwards the data to the AN_D and returns the L2 address of the AN_D to the AN_S. If the closer L-GW finds no related information locally, it sends a further address request to the farther L-GW, such as the root L-GW as shown in FIG. 5. This request may also be sent along with data. After the farther L-GW determines the L2 address of the AN_D, it may forward the data to the AN_D and return the L2 address of the AN_D to the closer L-GW. Upon the reception of the L2 address of the AN_D, the closer L-GW stores the address. Thus, the closer L-GW may locally determine the L2 address of the AN_D when the address is requested subsequently.

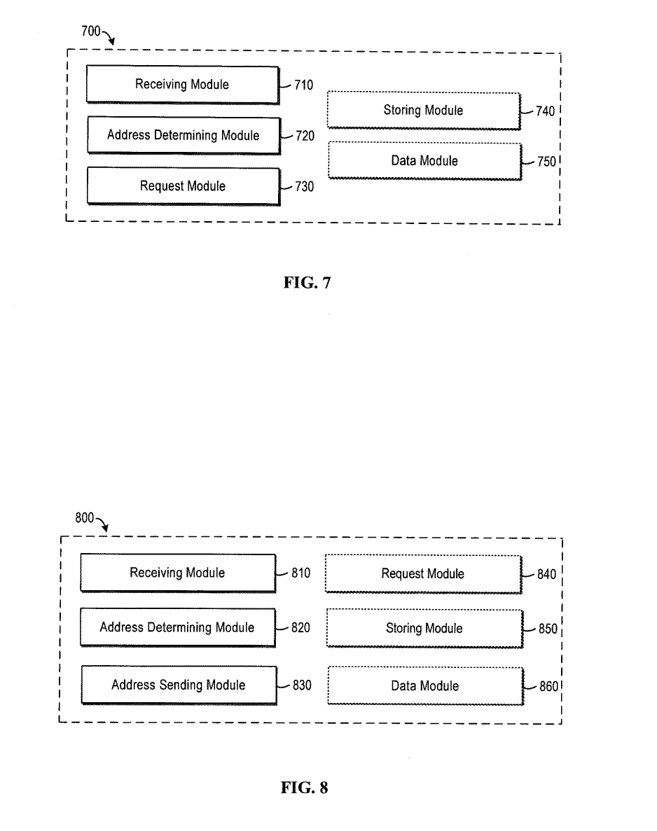

FIG. 7 shows a block diagram of an apparatus 700 for the address resolution in accordance with one embodiment of the present invention. It would be appreciated that the apparatus 700 may be implemented by an AN 120 as shown in FIG. 1.

As shown, the apparatus 700 comprises a receiving module 710, an address determining module, and a request module 730. The receiving module 710 is configured to receive a second-layer network address associated with a destination communication device (for instance, UE) from a source communication device in the wireless communication system, and then forward the second-layer network address to the address determining module 720. The address determining module 720 is configured to, responsive to the second-layer network address associated with the destination device being received, locally determine the first-layer network address from the second-layer network address. The request module 730 is configured to, responsive to the first-layer network address being unavailable in the address determining module 720, send a request for the first-layer network address to an address resolution server in the wireless communication system.

In one embodiment, the receiving module 730 is also configured to receive the first-layer network address from the address resolution server; and a storing module 740 configured to store the received first-layer network address in association with the second-layer network address.

In one embodiment, the second-layer network address is sent with data to be transmitted to the destination communication device. In this example, the apparatus 700 further comprises a data module 750 configured to transmit the data to the destination communication device based on the first-layer network address.

In one embodiment, the source communication device may include source UE, and the destination communication device may include a destination AN.

In one embodiment, the address resolution server may include a gateway entity.

In one embodiment, the first-layer network address may include a layer-2 network address, and the second-layer network address includes a layer-3 network address.

FIG. 8 shows a block diagram of an apparatus 800 for address resolution in accordance with one embodiment of the present invention. It would be appreciated that the apparatus 800 may be implemented by an L-GW 130 as shown in FIG. 1.

As shown, the apparatus 800 comprises a receiving module 810, an address determining module 820, and an address sending module 830. The receiving module 810 is configured to receive a request for a first-layer network address of a destination communication device from a source communication device in the wireless communication system. The address determining module 820 is configured to responsive to receiving the request, locally determine the first-layer network address from a second-layer network address associated with the destination communication device. The address sending module 830 is configured to send the first-layer network address to the source communication device, such that the source communication device directly communicates with the destination communication device based on the first-layer network address.

In one embodiment, the apparatus 800 further comprises a request module 840 configured to, responsive to the first-layer network address being unavailable, send a request for the first-layer network address to an address resolution server in the wireless communication system. The receiving module 810 is also configured to receive the first-layer network address from the address resolution server. The apparatus 800 also comprises a storing module 850 configured to store the received first-layer network address in association with the second-layer network address.

In one embodiment, the request is sent with data to be transmitted to the destination communication device. In this example, the apparatus 800 further comprises a data module 860 configured to transmit the data received by the receiving module 810 to the destination communication device based on the first-layer network address.

In one embodiment, the source communication device includes a source AN, and the destination communication device includes a destination AN.

In one embodiment, the address resolution server includes a further gateway entity.

In some embodiments, the first-layer network address includes a layer-2 network address and the second-layer network address includes a layer-3 network address. In some embodiments, the first-layer network address includes a layer-1 network address and the second-layer network address includes a layer-2 network address.

It should be appreciated that modules included in the apparatuses 700 and 800 corresponds to the steps of the methods 200 and 400. Therefore, all operations and features described above with reference to FIGS. 2 and 4 are likewise applicable to the modules included in the apparatuses 700 and 800 and have similar effects. For the purpose of simplification, the details will be omitted.

The modules included in the apparatuses 600 and/or 700 may be implemented in various manners, including software, hardware, firmware, or any combination thereof. In one embodiment, one or more modules may be implemented using software and/or firmware, for example, machine-executable instructions stored on the storage medium. In addition to or instead of machine-executable instructions, parts or all of the modules in the apparatuses 700 and/or 800 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

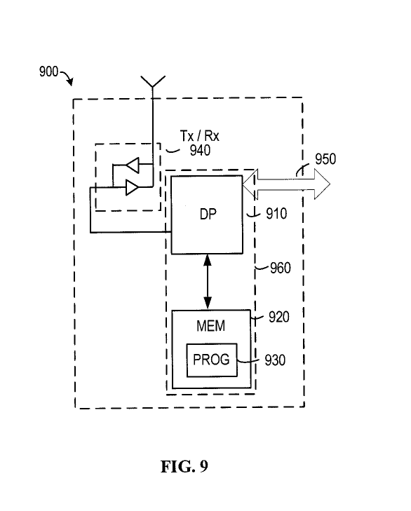

FIG. 9 illustrates a simplified block diagram of an apparatus 900 that is suitable for use in implementing embodiments of the present invention. The apparatus 900 may be implemented at least by an AN 120 or an L-GW 130 as shown in FIG. 1.

As shown in FIG. 9, the apparatus 900 includes a data processor (DP) 910, a memory (MEM) 920 coupled to the DP 910, a suitable RF transmitter TX and receiver RX 940 coupled to the DP 910, and a communication interface 950 coupled to the DP 910. The MEM 920 stores a program (PROG) 930. The TX/RX 940 is for bidirectional wireless communications. Note that the TX/RX 940 has at least one antenna to facilitate communication, though in practice an Access Node mentioned in this application may have several ones. The communication interface 950 may represent any interface that is necessary for communication with other network elements, such as X2 interface for bidirectional communications between eNBs, Si interface for communication between a Mobility Management Entity (MME)/Serving Gateway (S-GW) and the eNB, or Un interface for communication between the eNB and a relay node (RN). The apparatus 900 may be coupled via a data path to one or more external networks or systems, such as the internet, for example. The Serving Gateway may be the L-GW and the eNB may be the Access Node.

The PROG 930 is assumed to include program instructions that, when executed by the associated DP 910, enable the apparatus 900 to operate in accordance with the embodiments of the present invention, as discussed herein with the method 200 in FIG. 2 and/or the method 400 in FIG. 4.

The embodiments herein may be implemented by computer software executable by the DP 910 of the apparatus 900, or by hardware, or by a combination of software and hardware.

A combination of the data processor 910 and MEM 920 may form processing means 960 adapted to implement various embodiments of the present invention.

The MEM 920 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the apparatus 900, there may be several physically distinct memory units in the apparatus 900. The DP 910 may be of any type suitable to the local technical environment, and may include one or more of general purpose computers, special purpose computers, microprocessors, digital signal processors (DSPs) and processors based on multicore processor architecture, as non-limiting examples. The apparatus 900 may have multiple processors, such as an application specific integrated circuit chip that is slaved in time to a clock which synchronizes the main processor.

Generally, various embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present invention can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this invention, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present invention, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present invention has been described in language specific to structural features and/or methodological acts, it is to be understood that the present invention defined in the appended claims is not necessarily limited to the specific features or acts described above. Rather, the specific features and acts described above are disclosed as example forms of implementing the claims.

1. A method implemented at least in part by an access node of address resolution in a wireless communication system, the method comprising:
receiving a second-layer network address associated with a destination communication device from a source communication device in the wireless communication system;
locally determining a first-layer network address of the destination communication device from the second-layer network address; and
responsive to the first-layer network address being unavailable, sending a request for the first-layer network address to an address resolution server in the wireless communication system.

2. The method according to claim 1, further comprising:
receiving the first-layer network address from the address resolution server; and
storing the received first-layer network address in association with the second-layer network address.

3. The method according to claim 1, wherein the second-layer network address is sent with data to be transmitted to the destination communication device, the method further comprising:
transmitting the data to the destination communication device according to the first-layer network address.

4. The method according to claim 1, wherein the source communication device includes source user equipment and the destination communication device includes a destination access node.

5. The method according to claim 1, wherein the address resolution server includes a gateway entity.

6. The method according to claim 1, wherein the first-layer network address includes a layer-2 network address and the second-layer network address includes a layer-3 network address.

7-21. (canceled)

22. An apparatus implemented at least in part by an access node for address resolution in a wireless communication system, the apparatus comprising:
a processor; and
a memory including computer-executable instructions which, when executed by the processor, cause the apparatus to:
receive a second-layer network address associated with a destination communication device from a source communication device in the wireless communication system;
responsive to receiving the second-layer network address, locally determine a first-layer network address of the destination communication device from the second-layer network address;
responsive to the first-layer network address being unavailable, send a request for the first-layer network address to an address resolution server in the wireless communication system; and
receive the first-layer network address from the address resolution server.

23. An apparatus implemented at least in part by a gateway entity for address resolution in a wireless communication system, the apparatus comprising:
a processor; and
a memory including computer-executable instructions which, when executed by the processor, cause the apparatus to:
responsive to receiving a request for a first-layer network address of a destination communication device from a source communication device in the wireless communication system, locally determine the first-layer network address from a second-layer network address associated with the destination communication device; and
send the first-layer network address to the source communication device, such that the source communication device directly communicates with the destination communication device based on the first-layer network address.

24. The apparatus according to claim 22, wherein according to the instruction included in the memory, when executed by the processor, the apparatus is further caused to store the received first-layer network address in association with the second-layer network address.

25. The apparatus according to claim 22, wherein the second-layer network address is sent with data to be transmitted to the destination communication device, when executed by the processor, the apparatus is further caused to transmit the data to the destination communication device according to the first-layer network address.

26. The apparatus according to claim 22, wherein the source communication device includes source user equipment and the destination communication device includes a destination access node.

27. The apparatus according to claim 22, wherein the address resolution server includes a gateway entity.

28. The apparatus according to claim 22, wherein the first-layer network address includes a layer-2 network address and the second-layer network address includes a layer-3 network address.

29. The apparatus according to claim 23, according to the instructions included in the memory, when executed by the processor, the apparatus is further caused to:
responsive to the first-layer network address being unavailable, send a request for the first-layer network address to an address resolution server in the wireless communication system;
receive the first-layer network address from the address resolution server; and
store the received first-layer network address in association with the second-layer network address.

30. The apparatus according to claim 23, wherein the request is sent from the source communication device with data to be transmitted to the destination communication device, according to the instructions included in the memory, the apparatus is further caused to:
transmitting the data to the destination communication device according to the first-layer network address.

31. The apparatus according to claim 23, wherein the source communication device includes a source access node and the destination communication device includes a destination access node.

32. The apparatus according to claim 23, wherein the first-layer network address includes a layer-2 network address and the second-layer network address includes a layer-3 network address.
